(19) United States
(12) Patent Application Publication
(10) Pub. No.: US 2025/0304036 A1
(43) Pub. Date: Oct. 2, 2025

(54) CONTROL APPARATUS FOR FUEL CELL ELECTRIC VEHICLE

(71) Applicant: TOYOTA JIDOSHA KABUSHIKI KAISHA, Toyota-shi (JP)

(72) Inventors: Keisuke OYAMA, Nisshin-shi (JP); Yohei SUZUKI, Handa-shi (JP)

(73) Assignee: TOYOTA JIDOSHA KABUSHIKI KAISHA, Toyota-shi (JP)

(21) Appl. No.: 19/057,644

(22) Filed: Feb. 19, 2025

(30) Foreign Application Priority Data
Mar. 29, 2024 (JP) 2024-057449

(51) Int. Cl. B60W 30/06; B60L 58/30; H01M 8/04119

(52) U.S. Cl. CPC B60W 30/06; B60L 58/30; H01M 8/04179; B60W 2420/403; H01M 2250/20

(57) ABSTRACT

A control apparatus for a fuel cell electric vehicle is applied to the fuel cell electric vehicle having a water storage tank configured to store water produced in a fuel cell configured to generate an electric power to drive the fuel cell electric vehicle. The control apparatus comprises a camera configured to obtain image data by taking a picture of a scene of surrounding area of the fuel cell electric vehicle; and a controller configured to control drainage of the water from the water storage tank. The controller is configured to: execute a driving assistance control to move the fuel cell electric vehicle from a current position to a predetermined target position, based on the obtained image data; and control the drainage of the water based on the image data, while the driving assistance control is being executed.

### TECHNICAL FIELD

The present disclosure relates to a control apparatus applied to a vehicle on which a fuel cell is mounted for draining/discharging water produced by the fuel cell.

### BACKGROUND

Fuel cells generate electricity through a chemical reaction between hydrogen and oxygen. In this process, water is produced. A fuel cell electric vehicle on which the fuel cell is mounted stores the water produced by the fuel cell in a water storage tank, and drains the water from the water storage tank at a certain timing to the outside of the vehicle.

In order to avoid a situation where the water is drained from the fuel cell electric vehicle at an inappropriate position, a conventional control apparatus suppresses drainage from the water storage tank when a “current position of the fuel cell electric vehicle” obtained based on GPS signals from GPS satellites is at a predetermined position (refer to Japanese Patent Application Laid-Open No. 2015-118886).

### SUMMARY

However, the current position of the fuel cell electric vehicle obtained based on the GPS signals (electric waves) from the GPS satellites may include a large error with respect to an actual position of the vehicle. Therefore, the conventional apparatus may drain the water at a position where the drainage of the water should be suppressed. In particular, for a user who does not want the vehicle to drain the water in pre-determined locations such as a parking space/lot at home or a parking space at a workplace, the conventional apparatus may not be able to fully satisfy their needs. This disclosure is made to cope with such a problem.

A control apparatus for a fuel cell electric vehicle according to some of embodiments of the present disclosure is applied to the fuel cell electric vehicle having a water storage tank (33) configured to store water produced in a fuel cell (32) configured to generate an electric power to drive the fuel cell electric vehicle. The control apparatus for the fuel cell electric vehicle comprises a camera (71-74) configured to obtain image data by taking a picture of a scene of surrounding area of the fuel cell electric vehicle; and a controller (10, 30) configured to control drainage of the water from the water storage tank.

The controller is configured to:
execute a driving assistance control to move the fuel cell electric vehicle from a current position to a predetermined target position, based on the obtained image data; and
control the drainage of the water based on the image data (S420, S430, S450, S460), while the driving assistance control is being executed (S410: Yes, S440: Yes).

According to the above-described embodiment, while the driving assistance control is being executed based on the image data to cause the fuel cell electric vehicle to move to the predetermined target position, the drainage of the water from the water storage tank is controlled based on the image data. The position of the fuel cell electric vehicle relative to the predetermined target position can be accurately obtained based on the image data. Therefore, according to the above-described embodiment, when the fuel cell electric vehicle is located at a predetermined position with respect to the target position, the drainage of the water from the water storage tank is allowed/permitted and/or stopped/prohibited. Consequently, it is possible to avoid a situation where the drainage of the water from the water storage tank is performed when the fuel cell electric vehicle is located at a position at which the user does not want the water to be discharged from the water storage tank.

Notably, in the above description, in order to facilitate understanding of the present disclosure, the constituent elements corresponding to those of an embodiment which will be described later are accompanied by parenthesized symbols and/or names which are used in the embodiment; however, the constituent elements of the disclosure are not limited to those in the embodiment defined by the symbols and/or names. The present disclosure also covers a vehicle control method and a non-transitory computer readable medium having stored program thereof.

### BRIEF DESCRIPTION OF THE DRAWINGS

FIG. 1 is a schematic diagram of a control apparatus for a fuel cell electric vehicle according to an embodiment of the present disclosure.

FIG. 2 is a plan view of a fuel cell electric vehicle on which the control apparatus for the fuel cell electric vehicle according to the embodiment of the present disclosure is mounted.

FIG. 3A is a plan view showing a relationship between the fuel cell electric vehicle and a target position.

FIG. 3B is a plan view showing a relationship between the fuel cell electric vehicle and the target position.

FIG. 3C is a plan view showing a relationship between the fuel cell electric vehicle and the target position.

FIG. 3D is a plan view showing a relationship between the fuel cell electric vehicle and the target position.

FIG. 4 shows a routine executed by a CPU of a vehicle control ECU shown in FIG. 1.

FIG. 5 shows a routine executed by a CPU of a powertrain ECU shown in FIG. 1.

FIG. 6A is a plan view showing a relationship between the fuel cell electric vehicle and the target position.

FIG. 6B is a plan view showing a relationship between the fuel cell electric vehicle and the target position.

FIG. 6C is a plan view showing a relationship between the fuel cell electric vehicle and the target position.

FIG. 6D is a plan view showing a relationship between the fuel cell electric vehicle and the target position.

### DETAILED DESCRIPTION

### (Configuration)

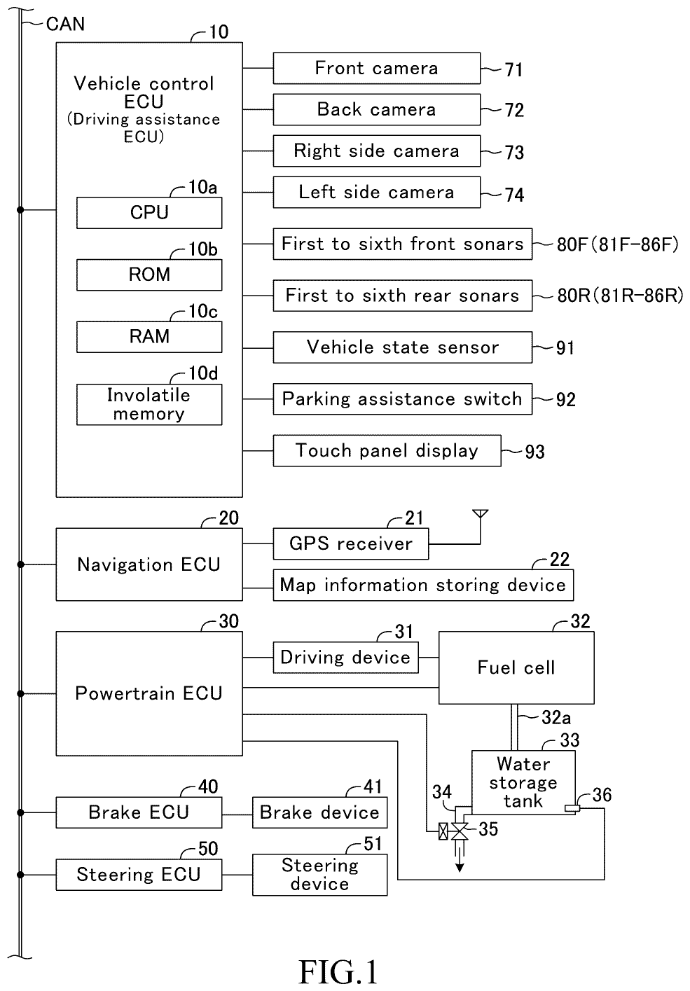

A control apparatus (hereinafter, referred to as an “implementing apparatus”) according to an embodiment of the present disclosure is applied to (or is mounted on) a vehicle (namely, a fuel cell electric vehicle) HV on which a fuel cell 32 is mounted, as shown in FIG. 1.

The implementing apparatus comprises a vehicle control ECU 10, a navigation ECU 20, a powertrain ECU 30, a brake ECU 40, and a steering ECU 50.

In the present specification, an ECU means an electronic control device (i.e., a control unit) comprising a microcomputer. The microcomputer comprises a CPU (i.e., a processor), a ROM, a RAM, data writable involatile memory, and an interface (I/F). The ECU is referred to as a controller or a computer. The above-described ECUs are connected to each other through Controller Area Network (CAN) in such a manner that they can exchange data with each other. All or some of a plurality of these ECUs may be integrated into a single ECU. In addition, one of the ECUs may be implemented by a plurality of ECUs.

The vehicle control ECU 10 comprises a CPU 10a, a ROM 10b, a RAM 10c, and an involatile memory 10d. The vehicle control ECU 10 receives, every time a predetermined time elapses, signals form a front camera 71, a back camera 72, a right side camera 73, a left side camera 74, a first to sixth front sonars 80F, a first to sixth rear sonars 80R, a vehicle state sensor 91, and a parking assistance switch 92. The vehicle control ECU 10 is connected with a touch panel display 93 to control images displayed on the display 93.

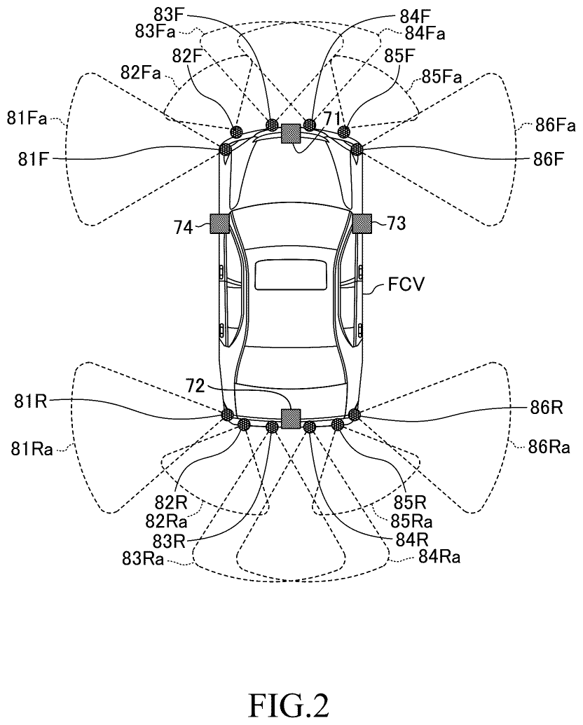

The cameras 71-74 are disposed at respective positions shown in FIG. 2. Each of the cameras 71-74 comprises a wide-angle lens.

The front camera 71 takes a picture of a front scene of the vehicle to produce a front wide angle image data.

The back camera 72 takes a picture of a rear scene of the vehicle to produce a rear wide angle image data.

The right side camera 73 takes a picture of a rightward scene of the vehicle to produce a rightward wide angle image data.

The left side camera 74 takes a picture of a leftward scene of the vehicle to produce a leftward wide angle image data.

The vehicle control ECU 10 generates/produces, based on the image data from the cameras 71-74, a surrounding image indicating a surrounding of the fuel cell electric vehicle FCEV, every time a predetermined time elapses, and causes the display 93 to display the surrounding image. The surrounding image includes a viewpoint image which is an image of the fuel cell electric vehicle FCEV viewed from a predetermined viewpoint above the fuel cell electric vehicle FCEV (including a bird's eye view image) and an image (i.e., travel direction image) in the direction in which the fuel cell electric vehicle FCEV is traveling.

The vehicle control ECU 10 performs an image analysis processing on the surrounding image generated based on the image data to detect (extract/recognize) feature points included in the surrounding image. The vehicle control ECU 10 groups the feature points for each of “a three-dimensional structure, a set of patterns on the road/ground surface, and a demarcation line on the road/ground surface”. The vehicle control ECU 10 obtains, as feature point information, a “shape” of the grouped feature points and a “positional relationship” between the grouped feature points and the fuel cell electric vehicle FCEV, and stores them in the involatile memory 10d.

The first to sixth front sonars 80F include the first to sixth front sonars 81F-86F that are disposed at the front end of the fuel cell electric vehicle FCEV, as shown in FIG. 2. The first to sixth rear sonars 80R include the first to sixth rear sonars 81R-86R that are disposed at the rear end of the fuel cell electric vehicle FCEV, as shown in FIG. 2. Object detection areas (i.e., ultrasonic wave irradiation areas) of these sonars are denoted by 81Fa to 86Fa, and 81Ra to 86Ra, respectively. For example, the area denoted by 81Fa is the object detection area of the first front sonar 81F.

Each sonar irradiates an ultrasonic wave to the respective object detection area, and receives a reflection wave. The object generates the reflection wave by reflecting the irradiated ultrasonic wave. Each sonar transmits, to the vehicle control ECU 10, sonar information including a time length from a time point at which it starts to irradiate the ultrasonic wave to a time point at which it receives the reflection wave. The vehicle control ECU 10 obtains sonar object information indicative of a position of a reflection point with respect to the fuel cell electric vehicle FCEV, based on the sonar information from each of the sonars and the triangulation method.

The vehicle control ECU 10 fuses/integrates the feature point information and the sonar object information to obtain “a final position of the object, a final position of the patterns on the road/ground surface, or the like” with respect to the fuel cell electric vehicle FCEV (refer to Japanese Patent Application Laid-Open No. 2021-135191, for example). Information indicating the final position of “the object, the final position of the patterns on the road/ground surface, or the like” with respect to the fuel cell electric vehicle FCEV is referred to as “image/sonar fusion information”. As is apparent, the image/sonar fusion information is information including the feature point information obtained based on the surrounding image that is generated based on the image data.

The vehicle state sensor 91 includes various sensors to obtain parameters indicative of a state of the fuel cell electric vehicle FCEV. For example, the vehicle state sensor 91 includes a vehicle speed sensor which detects a vehicle speed (i.e., a host vehicle speed) Vh, a shift position sensor, a steering angle sensor, a steering torque sensor, an acceleration pedal operation amount sensor, and a brake pedal operation amount sensor.

The parking assistance switch 92 is operated by a user of the fuel cell electric vehicle FCEV for the user to require various parking assistances provided by the vehicle control ECU 10 when the user parks the fuel cell electric vehicle FCEV or lets the fuel cell electric vehicle FCEV leave the parked position.

The touch panel display 93 displays various images including touch buttons and the above-described surrounding image.

The navigation ECU 20 constitutes a well-known navigation system together with a GPS receiver 21 and a map information storing device 22. The navigation ECU 20 obtains a “current position of the fuel cell electric vehicle FCEV” represented by a latitude and a longitude, based on the GPS signals (i.e., signals from positioning satellites) which the GPS receiver 21 receives.

The powertrain ECU 30 controls a driving device 31 including an electric motor serving as the drive source of the fuel cell electric vehicle FCEV, so as to adjust a driving force of the fuel cell electric vehicle FCEV and a shift position. The powertrain ECU 30 controls a fuel cell 32 so as to generate electricity that is supplied to the driving device 31. The fuel cell 32 generates electric power through a chemical reaction between hydrogen and oxygen. When the electric power is generated, water is produced. The water is discharged from the fuel cell 32 to a water storage tank 33 through a pipe 32a. The water storage tank 33 is a tank to store the water discharged from the fuel cell 32, and comprises a drain pipe 34, a drain valve which opens and closes the drain pipe 34, a water amount sensor 36 that detects an amount of the water stored in the water storage tank 33. The powertrain ECU 30 obtains a tank water amount (stored water amount) WL in the water storage tank 33 using the water amount sensor 36. The powertrain ECU 30 can open and close the drain valve 35.

The brake ECU 40 controls a brake device 41 of the fuel cell electric vehicle FCEV, so as to adjust a brake force applied to the fuel cell electric vehicle FCEV. The steering ECU 50 controls a steering device 51 of the fuel cell electric vehicle FCEV, so as to change a steering assist force and the steering angle of the fuel cell electric vehicle FCEV.

### (Outline of Operation)

For example, the fuel cell electric vehicle FCEV is repeatedly parked into a target parking position/space in a specific place, such as a parking space of the home or a parking space at the workplace, and/or is repeatedly caused to move from the parking position/space in the specific place to a target departure position. Hereinafter, the target parking position and the target departure position may be referred to as a target position.

Many of the users do not want that the water is drained from the water storage tank in the parking positions/spaces of their homes, the parking positions/spaces of their workplaces, or the like. The conventional apparatus prohibits draining the water from the water storage tank, when the current position of the vehicle obtained based on the GPS signals is at a predetermined position. However, the current position of the vehicle obtained based on the GPS signals may include a large error. Therefore, according to the conventional apparatus, even when the predetermined position (i.e., the water drainage suppression position) is set at the parking position of the home, the parking position of the workplace, or the like, the water may be drained in the parking position of the home, the parking position of the workplace, or the like.

In view of the above, the implementing apparatus executes a driving assistance control to move the fuel cell electric vehicle FCEV from the current position to a predetermined target position using the image/sonar fusion information including the feature point information obtained based on the image data, and it prohibits or allows the drainage of the water from the water storage tank 33 when it is determined, based on the image/sonar fusion information, that the fuel cell electric vehicle FCEV has approached the target position while the driving assistance control is being executed.

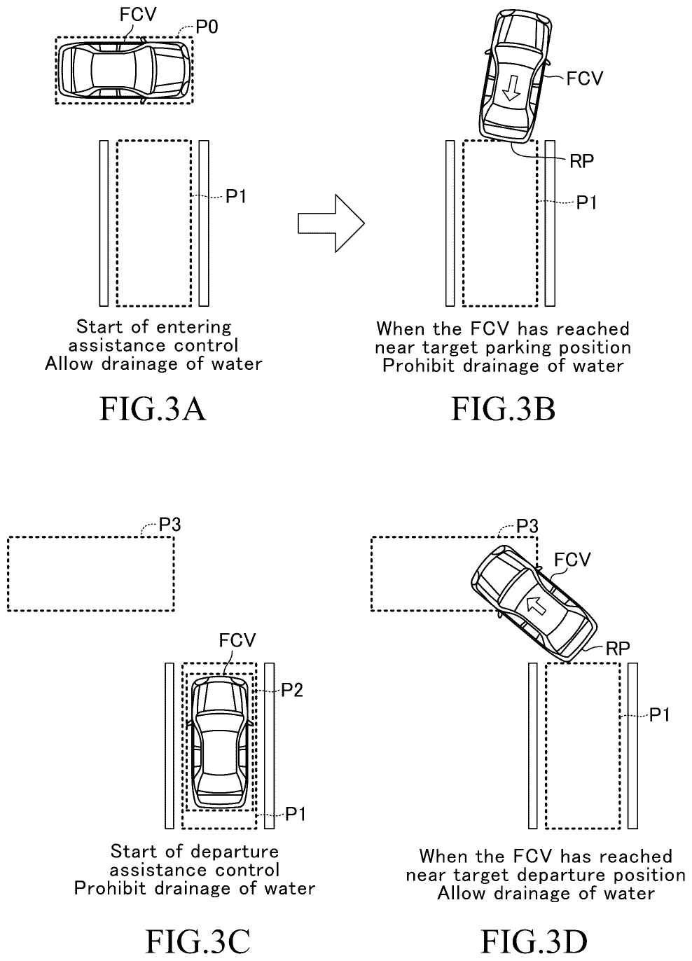

For example, as shown in FIG. 3A, when the implementing apparatus executes, as the driving assistance control, an entering assistance control (i.e., parking assistance control) to automatically move the fuel cell electric vehicle FCV (i.e., FCEV) from the current position P0 to the target parking position P1 to park it there, the implementing apparatus prohibits the drainage of the water from the water storage tank 33 when the a traveling direction end (in this case, a rear end of the vehicle) RP has reached the target parking position P1 during the execution of the entering assistance control, as shown in FIG. 3B.

Furthermore, for example, as shown in FIG. 3C, when the implementing apparatus executes, as the driving assistance control, a departure assistance control to automatically move the fuel cell electric vehicle FCV from the current position P2 to the target departure position P3, the implementing apparatus allows the drainage of the water from the water storage tank 33 when the traveling direction end (in this case, a front end of the vehicle) has entered the target departure position P3 during the execution of the departure assistance control, as shown in FIG. 3D.

The entering assistance control and the departure assistance control are both executed based on the image/sonar fusion information. Since the position of the fuel cell electric vehicle FCV relative to the target position can be accurately obtained based on the image/sonar fusion information, the implementing apparatus can certainly prevent the drainage of the water from the water storage tank 33 at/in the target parking position P1 where the user does not want the drainage of the water.

### (Specific Operation)

### 1. Setting of Drainage Prohibition Flag XK

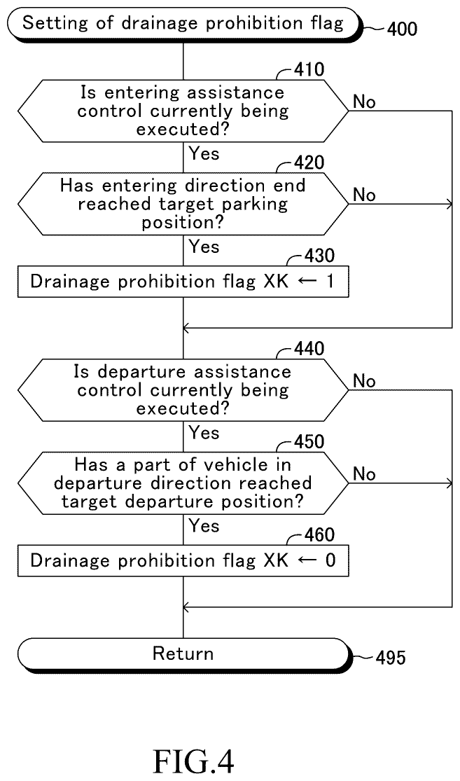

The CPU 10a of the vehicle control ECU 10 executes a routine shown by a flowchart in FIG. 4, every time a predetermined time elapses.

When an appropriate time point comes, the CPU 10a starts processing from step 400 (hereinafter, “step” is expressed as “S”) shown in FIG. 4, and proceeds to S410. At S410, the CPU 10a determines whether or not an entering assistance control after registration is currently being executed. As described later in detail, the entering assistance control after registration is the driving assistance control to automatically move the fuel cell electric vehicle FCV from the current position P0 of the fuel cell electric vehicle FCV to the “target parking position P1 that has been registered/stored in the involatile memory 10d in advance while being associated with the image/sonar fusion information” to park the vehicle FCV in the target parking position P1.

When the entering assistance control after registration is not currently being executed, the CPU 10a directly proceeds to S440 from S410. Whereas, the entering assistance control after registration is currently being executed, the CPU 10a proceeds to S420 from S410. At S420, the CPU 10a determines whether or not an entering direction end RP (e.g., the rear end RP) of the fuel cell electric vehicle FCV has reached the target parking position P1 based on the image/sonar fusion information, as shown in FIG. 3B.

When the entering direction end RP has not reached the target parking position P1, the CPU 10a directly proceeds to S440 from S420. Whereas, when the entering direction end RP has reached the target parking position P1, the CPU proceeds to S430 from S420 to set the value of the drainage prohibition flag XK to “1 “, and thereafter, proceeds to S440. The value of the drainage prohibition flag XK to “1” is stored in the involatile memory 10d. As described later, when the value of the drainage prohibition flag XK is “1 “, the drainage of the water from the water storage tank 33 is prohibited.

When the CPU 10a proceeds to S440, the CPU 10a determines whether or not a departure assistance control after registration is currently being executed. As described later in detail, the departure assistance control after registration is the driving assistance control to automatically move the fuel cell electric vehicle FCV from the current position P2 (i.e., the parked position) of the fuel cell electric vehicle FCV to the “target departure position P3 that has been registered/stored in the involatile memory in advance while being associated with the image/sonar fusion information”.

When the departure assistance control after registration is not being executed, the CPU 10a directly proceeds to S495 from S440 to terminate the present routine tentatively. Whereas, the departure assistance control after registration is being executed, the CPU 10a proceeds to S450 from S440 to determine, based on the image/sonar fusion information, a part of the fuel cell electric vehicle FCV in the departure direction (e.g., the front end of the vehicle) has reached the target departure position P3 (i.e., whether the part of the vehicle FCV has entered into the target departure position P3).

When the part of the fuel cell electric vehicle FCV in the departure direction has not reached the target departure position P3, the CPU 10a directly proceeds to S495 from S450. Whereas, when the part of the fuel cell electric vehicle FCV in the departure direction has reached the target departure position P3, the CPU 10a proceeds to S460 from S450 to set the value of the drainage prohibition flag XK to “0”, and thereafter, proceeds to S495. As described later, when the drainage prohibition flag XK is “0”, the drainage of the water from the water storage tank 33 is allowed.

### 2. Water Drainage Control

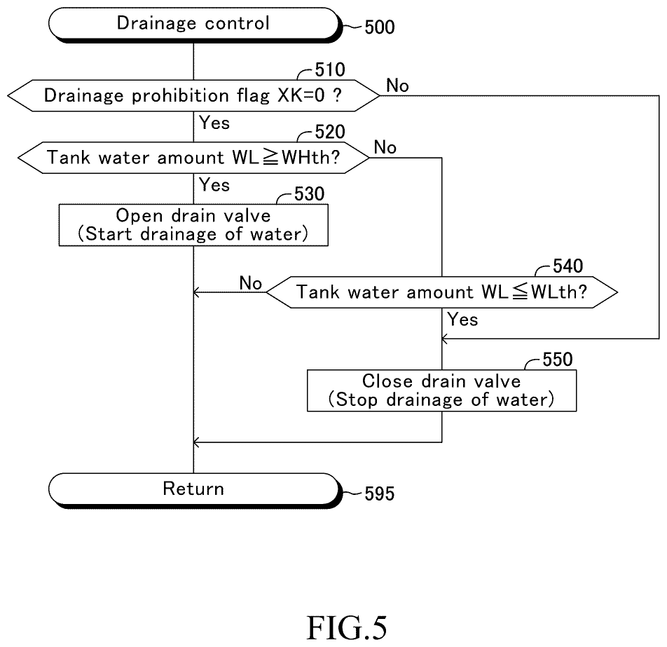

When the CPU of the powertrain ECU 30 (hereinafter, referred to as the “CPU 30a”) executes a routine shown by a flow chart in FIG. 5, every time a predetermined time elapses. When an appropriate time point comes, the CPU 30a starts processing from S500 shown in FIG. 5, and proceeds to S510. At S510, the CPU 30a determines whether or not the value of the drainage prohibition flag XK, which the CPU 10a sets, is “0”.

When the value of the drainage prohibition flag XK is “0” (i.e., when the drainage of the water from the water storage tank 33 is allowed), the CPU 30a proceeds to S520 from S510 to determine whether or not the tank water amount (stored water amount) WL is equal to or greater than a predetermined first water amount threshold (i.e., high side water amount threshold) WHth.

When the tank water amount WL is equal to or greater than the predetermined first water amount threshold WHth, the CPU 30a proceeds to S530 from S520 to open the drain valve 35 to execute the drainage of the water from the water storage tank 33. Thereafter, the CPU 30a proceeds to S595 to terminate the present routine tentatively.

Whereas, when the CPU 30a proceeds to S520, if the tank water amount WL is smaller than the predetermined first water amount threshold WHth, the CPU 30a proceeds to S540 from S520. At S540, the CPU 30a determines whether or not the tank water amount (stored water amount) WL is equal to or smaller than a predetermined second water amount threshold (i.e., low side water amount threshold) WLth. The second water amount threshold (i.e., low side water amount threshold) WLth has been set at a value smaller than the first water amount threshold (i.e., high side water amount threshold) WHth. For example, the second water amount threshold WLth is “0”.

When the tank water amount WL is greater than the second water amount threshold WLth, the CPU 30a directly proceeds to S595 from S540 to terminate the present routine tentatively.

Whereas, when the tank water amount WL is equal to or smaller than the second water amount threshold WLth, the CPU 30a proceeds to S550 from S540 to close the drain valve 35 to stop the drainage of the water from the water storage tank 33. Thereafter, the CPU 30a proceeds to S595.

Furthermore, when the CPU proceeds to S510, if the value of the drainage prohibition flag XK is “1” (i.e., if the drainage of the water from the water storage tank 33 is prohibited), the CPU 30a directly proceeds to S550 from S510 to close the drain valve 35. Therefore, in this case, the drainage of the water from the water storage tank 33 is not performed (i.e., the drainage of the water from the water storage tank 33 is prohibited) regardless of the tank water amount WL.

### 3. Entering Assistance Control

When the speed Vh of the fuel cell electric vehicle FCV is zero or in the vicinity of zero and the parking assistance switch 92 is operated, the vehicle control ECU 10 searches for a space in which the fuel cell electric vehicle FCV can be parked (or can be entered), based on vehicle surrounding information such as the above-described image/sonar fusion information and radar object information obtained by unillustrated radars. When the vehicle control ECU 10 detects/finds the space(s) in which the fuel cell electric vehicle FCV can be parked, the vehicle control ECU 10 sets a “candidate target parking position (space)” in each of the spaces in which the fuel cell electric vehicle FCV can be parked, and causes the display 93 to display the image in which each candidate target parking position is superimposed on each of the bird's eye view image and the travel direction image.

When one of the candidate target parking positions is selected/determined by the operation by the user to the display 93 as a “space (i.e., target parking position) to which the fuel cell electric vehicle FCV should be moved”, the vehicle control ECU 10 produces a path from the current position of the fuel cell electric vehicle FCV to the target parking position, as a target entering path.

In a state where the target entering path has been produced, when the entering (parking) assistance start button displayed on the display 93 is operated, the vehicle control ECU 10 transmits instruction signals to the powertrain ECU 30, the brake ECU 40, and the steering ECU 50, in such a manner that the fuel cell electric vehicle FCV travels along the target entering path. As a result, the fuel cell electric vehicle FCV is moved along the target entering path.

When the vehicle control ECU 10 determines that parking of the fuel cell electric vehicle FCV is complete after the entering assistance start button is operated, and when the user operates a parking position registration button displayed on the display 93, the vehicle control ECU 10 obtains, from the navigation ECU 20, the current position (represented by latitude and longitude) of the fuel cell electric vehicle FCV that is in the parked state. The vehicle control ECU 10 registers/stores the current position of the fuel cell electric vehicle FCV in the involatile memory 10d, as a “registered parking point”.

The vehicle control ECU 10 stores the “image/sonar fusion information including the feature point information” obtained in an entering assistance period from a time point at which the entering assistance start button is operated to a time point at which the parking position registration button is operated, while associating the image/sonar fusion information with the registered parking point. As a result, an occupying space of the fuel cell electric vehicle FCV that is parked at the registered parking point is stored as the “registered parking position” in the involatile memory 10d while being associated with the “image/sonar fusion information including the feature point information”. This stored information is referred to as “registered feature point information”.

When the fuel cell electric vehicle FCV is positioned/located in the vicinity of the registered parking point after the registered parking point and the registered parking position have been registered, the vehicle control ECU 10 offers the entering assistance to the registered parking position serving as the target parking position. When the user of the fuel cell electric vehicle FCV desires to move the fuel cell electric vehicle FCV to the “registered parking position corresponding to the registered parking point” so as to park the vehicle FCV in the registered parking position, the user operates an entering assistance control execution button displayed on the display 93. This operation causes the vehicle control ECU 10 to execute the entering assistance control after registration (i.e., automatic parking).

Specifically, the vehicle control ECU 10 lets the fuel cell electric vehicle FCV travel, while comparing the actual feature point information successively obtained based on the image data with the registered feature point information, in such a manner that a “positional relationship between the fuel cell electric vehicle FCV and the grouped feature points represented by the actual feature point information” coincides with a “positional relationship between the fuel cell electric vehicle FCV and the grouped feature points represented by the registered feature point information” to move the fuel cell electric vehicle FCV to the registered parking position. In this case as well, the vehicle control ECU 10 transmits instruction signals to the powertrain ECU 30, the brake ECU 40, and the steering ECU 50. In this manner, the vehicle control ECU 10 executes the entering assistance control after registration.

The above-described “entering assistance control after registration of the registered parking point” is also referred to as a “path memorized type automatic parking control”, for convenience. The path memorized type automatic parking control is well-known, and is disclosed in detail in, for example, Japanese issued patent No. 7176421, Japanese Patent Application Laid-Open No. 2023-176547, and so forth.

### 4. Departure Assistance Control

When a position of an unillustrated start switch of the fuel cell electric vehicle FCV is changed from an off-position to an on-position, the vehicle control ECU 10 determines whether or not the current position of the fuel cell electric vehicle FCV substantially coincides with the registered parking point. When the current position of the fuel cell electric vehicle FCV substantially coincides with the registered parking point, the vehicle control ECU 10 searches for a space into which the fuel cell electric vehicle FCV can enter based on the vehicle surrounding information such as the above-described image/sonar fusion information and the radar object information obtained by the unillustrated radars. When the vehicle control ECU 10 detects/finds the space(s) into which the fuel cell electric vehicle FCV can enter, the vehicle control ECU 10 sets a “candidate target departure position (space)” at a certain position in each of the space(s) into which the fuel cell electric vehicle FCV can enter, and causes the display 93 to display the image in which each candidate target departure position is superimposed on each of the bird's eye view image and the travel direction image.

When one of the candidate target departure positions is selected/determined by the operation by the user to the display 93 as a “space (i.e., target departure position) to which the fuel cell electric vehicle FCV should be moved”, the vehicle control ECU 10 produces a path from the current position of the fuel cell electric vehicle FCV to the target departure position, as a target departure path.

In a state where the target departure path has been produced, when the departure assistance start button displayed on the display 93 is operated, the vehicle control ECU 10 transmits instruction signals to the powertrain ECU 30, the brake ECU 40, and the steering ECU 50, in such a manner that the fuel cell electric vehicle FCV travels along the target departure path. As a result, the fuel cell electric vehicle FCV is moved along the target departure path.

When the vehicle control ECU 10 determines that the fuel cell electric vehicle FCV has reached the target departure position after the departure assistance start button is operated, and when the user operates a departure position registration button displayed on the display 93, the vehicle control ECU 10 obtains, from the navigation ECU 20, the current position (represented by latitude and longitude) of the fuel cell electric vehicle FCV. The vehicle control ECU 10 registers/stores the current position of the fuel cell electric vehicle FCV in the involatile memory 10d, as a “registered departure point”.

The vehicle control ECU 10 stores the “image/sonar fusion information including the feature point information” obtained in a departure assistance period from a time point at which the departure assistance start button is operated to a time point at which the departure position registration button is operated, while associating the image/sonar fusion information with the registered departure point. As a result, an occupying space of the fuel cell electric vehicle FCV that is stopped at the registered departure point is stored as the “registered departure position” in the involatile memory 10d while being associated with the “image/sonar fusion information including the feature point information”. This stored information is also referred to as “registered feature point information”.

When the current position of the fuel cell electric vehicle FCV substantially coincides with the registered parking point at a time point at which the position of the start switch of the fuel cell electric vehicle FCV is changed from the off-position to the on-position after the registered departure point and the registered departure position have been registered, the vehicle control ECU 10 offers the departure assistance to the registered departure position serving as the target departure position.

When the user operates a departure assistance control execution button displayed on the display 93, the vehicle control ECU 10 executes the departure assistance control after registration (i.e., automatic departure). Specifically, the vehicle control ECU 10 automatically moves the fuel cell electric vehicle FCV to the registered departure position, based on a “positional relationship between the fuel cell electric vehicle FCV and the grouped feature points represented by the actual feature point information” and a “positional relationship between the fuel cell electric vehicle FCV and the grouped feature points represented by the registered feature point information”. Namely, the vehicle control ECU 10 executes the departure assistance control after registration. In this case as well, the vehicle control ECU 10 transmits instruction signals to the powertrain ECU 30, the brake ECU 40, and the steering ECU 50.

As has been described, according to the implementing apparatus, while the “driving assistance control (e.g., the entering assistance control after registration or the departure assistance control after registration) to let the fuel cell electric vehicle FCV automatically move to the predetermined target position (e.g., the target parking position or the target departure position) based on the image data (i.e., the image/sonar fusion information including the feature point information obtained based on the surrounding image that is produced based on the image data)” is being executed, the drainage of the water from the water storage tank 33 is controlled based on the image data (i.e., the image/sonar fusion information including the feature point information obtained based on the surrounding image that is produced based on the image data). The position of the fuel cell electric vehicle FCV with respect to the predetermined target position can be accurately obtained based on the image data (i.e., the image/sonar fusion information including the feature point information obtained based on the surrounding image that is produced based on the image data). Therefore, according to the above embodiment, the drainage of the water from the water storage tank 33 is allowed/permitted and/or prohibited, when the fuel cell electric vehicle FCV is at the predetermined position with respect to the target position. Consequently, the implementing apparatus can avoid a “situation where the drainage of the water from the water storage tank 33 is performed when the fuel cell electric vehicle FCV is present/located at the inappropriate position the user does not desire”.

### First Modified Example

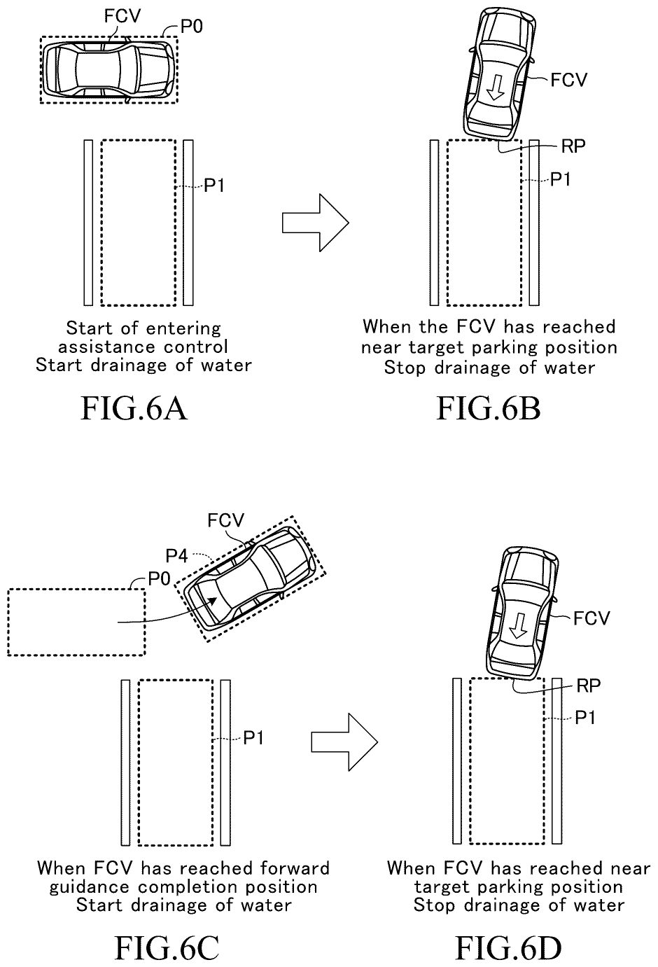

As shown in FIG. 6A, a first modified example of the implementing apparatus opens the drain valve 35 to drain the water from the water storage tank 33 regardless of the tank water amount (stored water amount) WL, when the user of the fuel cell electric vehicle FCV instructs to start the entering assistance control after registration corresponding to the registered parking point. Thereafter, as shown in FIG. 6B, the first modified example closes the drain valve 35 to stop drainage of the water from the water storage tank 33 regardless of the tank water amount (stored water amount) WL, when the entering direction end RP of the fuel cell electric vehicle FCV reaches the target parking position P1.

### Second Modified Example

Some of the entering assistance control after registration may move the fuel cell electric vehicle FCV forward once, and then, move the fuel cell electric vehicle FCV backward to the target parking position. As shown in FIG. 6C, a second modified example of the implementing apparatus opens the drain valve 35 to drain the water from the water storage tank 33 regardless of the tank water amount (stored water amount) WL, when the fuel cell electric vehicle FCV reaches a position (i.e., the forward guidance completion position) P4 at which the traveling/moving direction of the fuel cell electric vehicle FCV is switched from the forward direction to the backward direction while executing the entering assistance control after registration corresponding to the registered parking point. Thereafter, as shown in FIG. 6D, the second modified example closes the drain valve 35 to stop drainage of the water from the water storage tank 33 regardless of the tank water amount (stored water amount) WL, when the entering direction end RP of the fuel cell electric vehicle FCV reaches the target parking position P1.

According to the first and second modified examples, the water in the water storage tank 33 can be drained/discharged as much as possible before the fuel cell electric vehicle FCV enters the target parking position to be parked. Therefore, for example, even when the water in the water storage tank 33 freezes to become ice while the fuel cell electric vehicle FCV is parked, it is possible to melt the ice in the water storage tank 33 in a short time, and thus, it is possible to start moving the fuel cell electric vehicle FCV in a short time.

It should be noted that the present disclosure is not limited to the above embodiment and modified examples, and may adopt various modifications within the scope of the present disclosure. For example, the present disclosure can be applied to the fuel cell electric vehicle FCV that is an autonomous driving vehicle. Namely, when the vehicle driving mode of that fuel cell electric vehicle FCV is changed from an autonomous driving mode to a mode where the driver drives that fuel cell electric vehicle FCV, the present disclosure can be applied to that fuel cell electric vehicle FCV. Furthermore, at S450, the CPU 10a may determine whether or not an end opposite to the moving direction end of the fuel cell electric vehicle FCV (e.g., in the example shown in FIG. 3D, the rear end RP) has left the target parking position P1 based on the image/sonar fusion information, and may proceeds to S460 from S450 when the CPU 10 a determine that the end opposite to the moving direction end has left the target parking position P1.

What is claimed is:

1. A control apparatus for a fuel cell electric vehicle, applied to said fuel cell electric vehicle having a water storage tank configured to store water produced in a fuel cell configured to generate an electric power to drive said fuel cell electric vehicle, comprising:
a camera configured to obtain image data by taking a picture of a scene of surrounding area of said fuel cell electric vehicle; and
a controller configured to control drainage of said water from said water storage tank,
wherein,
said controller is configured to:
execute a driving assistance control to move said fuel cell electric vehicle from a current position to a predetermined target position, based on said obtained image data; and
control said drainage of said water based on said image data, while said driving assistance control is being executed.

2. The control apparatus according to claim 1,
wherein,
said controller is configured to:
store said predetermined target position in an involatile memory in advance while associating said predetermined target position with feature point information obtained based on said image data; and
execute said driving assistance control using said stored feature point information and actual feature point information obtained based on image data that is newly obtained by said camera.

3. The control apparatus according to claim 2,
wherein,
said predetermined target position is a target parking position that is set by a user of said fuel cell electric vehicle; and
said controller is configured to prohibit said drainage of said water from said water storage tank, when and after it is determined that a predetermined part of said fuel cell electric vehicle has reached said target parking position based on said actual feature point information while executing an entering assistance control as said driving assistance control to automatically move said fuel cell electric vehicle from a current position near said target parking position to said target parking position.

4. The control apparatus according to claim 3,
wherein,
said predetermined target position is a target departure position that is set by said user; and
said controller is configured to allow said drainage of said water from said water storage tank, when and after it is determined that a predetermined part of said fuel cell electric vehicle has entered said target departure position based on said actual feature point information while executing an departure assistance control as said driving assistance control to automatically move said fuel cell electric vehicle from a current position at which said fuel cell electric vehicle is parked to said target parking position.

5. The control apparatus according to claim 2,
wherein,
said predetermined target position is a target parking position that is set by a user of said fuel cell electric vehicle; and
said controller is configured to perform said drainage of said water from said water storage tank, in a period from at latest at a certain time point on and after a start time point of an entering assistance control as said driving assistance control to automatically move said fuel cell electric vehicle from a current position near said target parking position to said target parking position to a time point at which a part of said fuel cell electric vehicle is determined to enter said target parking position based on said actual feature point information, while executing said entering assistance control.

6. A vehicle control method applied to a fuel cell electric vehicle having a water storage tank configured to store water produced in a fuel cell configured to generate an electric power to drive said fuel cell electric vehicle, including:
a step of obtaining image data representing a scene of surrounding area of said fuel cell electric vehicle, using a camera;
a step of executing a driving assistance control to move said fuel cell electric vehicle from a current position to a predetermined target position, based on said obtained image data; and
a step of controlling drainage of said water from said water storage tank, based on said obtained image data, while said driving assistance control is being executed.
